(19) United States
(12) Patent Application Publication
(10) Pub. No.: US 2008/0146275 A1
(43) Pub. Date: Jun. 19, 2008

(54) Combination Device

(76) Inventor: Frank Tofflinger, Baldham (DE)

Correspondence Address: QUARLES & BRADY LLP, 411 E. WISCONSIN AVENUE, SUITE 2040, MILWAUKEE, WI, 53202-4497, US

(21) Appl. No.: 11/883,123

(22) PCT Filed: Feb. 9, 2006
(86) PCT No.: PCT/EP2006/001136

§ 371 Date: Jul. 25, 2007

(30) Foreign Application Priority Data
Feb. 23, 2005 (DE) 10 2005 008 545.8

(51) Int. Cl. H04Q 7/20; H04M 1/02

(52) U.S. Cl. 455/556.1; 455/566; 455/575.1

(57) ABSTRACT

The invention concerns a combination device consisting of a handheld housing. In the combination device, the functionality of a dictating device and a mobile telephone are integrated. The housing is provided with a visual display unit, an acoustic output unit, an acoustic input unit, and at least one tactile input unit. On the side of the combination device there is a switch, which is designed as a sliding switch.

Today mobile telephones are a fact of life and part of our communication system. They have numerous special functions, for example a mailbox function, call-forwarding, the function of an organizer, and other functions. At the same time, the market penetration of combinations of mobile phones and PDAs (Personal Digital Assistant) is also increasing. With such a combination it is possible to combine various functions that are known from the computer area with the functionality of telephoning and/or with that of a PDA, especially with the functionality of a so-called smartphone. Finally, it is known that a dictating function can be integrated into a mobile phone,

Thus, for example, a mobile telephone and a mobile dictating device in combination are known from DE 296 08 439 U1. Hereby, preferably, a dictating device is integrated into a mobile phone.

A mobile phone is known from DE 195 39 635 A1 with a keyboard for the input of numbers and function selection and with a digital function storage as well as a telephone access chip. Furthermore, operating elements are present there that equip the mobile phone to be used as a dictating device.

In the dictating devices presently on the market, it is known that a sliding switch can be arranged on the side. Such a sliding switch is realized, for example, in the digital dictating equipment called “Digta” made by the company Grundig Business Systems.

In the combination devices mentioned at the outset, a disadvantage is that most of the devices are very complex and complicated to operate and a user mostly cannot use the device intuitively. Frequently various functions are assigned to subfunctions and submenus, and the selection of these functions is controlled through multiple keystrokes. For example, it is hardly possible for the user, for example during frequent dictation or during dictation under certain circumstances, to operate the equipment without looking at it or to operate it with one hand. Specifically, the user control is not very comfortable or is even prohibitive for professional use because of the often relatively small operating keys, the double function keys (for example 2/A/B/C) or because of the not very ergonomic operation via touchscreens, for example also in combination with styli.

The task of the present invention is to provide a combination device consisting of a mobile telephone, especially a smartphone, and a dictating device, which is easy to operate and permits intuitive, easily-learned operation for a user. In addition, the equipment should serve to transmit and receive data.

This task is solved with the aid of the characteristics of patent claim 1. Advantageous embodiments follow from the additional dependent claims.

The combination device according to the invention presented a combination of a dictating device and a smartphone-mobile phone. It serves to transmit spoken information as well as to receive and send data. The combination device has a sufficiently large display. The display is optionally designed as a touchscreen. The combination device is easy to operate via the touchscreen with suitable input devices (for example PDA pen). The operation of the combination device and its functionality is, however, also possible with a keyboard (qwerty) that is attached and other operating elements.

Thus, it is possible to use the device both for phoning as well as for data input, data transmission and data reception as well as for the display and visualization of data.

Alternatively, there is also the possibility of operating input through the touchscreen using the fingers or with an input tool of a user, however, in this case the corresponding input fields must be dimensioned on the touchscreen sufficiently large in order not to trigger any unintended inputs or erroneous operations.

Specifically for the selection of a telephone number, the combination device has a keyboard that is arranged below the touchscreen. This keyboard is a known decimal keyboard where the keys have in addition double functions (2/A/B/C etc.). Above this decimal keyboard other keys are arranged, which take into consideration the extent of the functionality of the combination device. Below the decimal keyboard there is an acoustic input unit, specifically in the form of a microphone, through which speech input can occur. This microphone serves in the dictating operation for inputting speech, in the telephone operation for speaking and in the operation as PDA, using a speech recognition program that is present in the combination device, the functions of the PDA can be controlled with speech.

Above the touchscreen there is an acoustic output unit in the form of a loudspeaker. This serves for speech output in telephone operation, in dictation operation to reproduce the dictated material, and in the PDA operation for acoustical messaging and confirmation of performed functions. A rocker switch may be arranged on the left side of the combination device. On the right side a sliding switch is arranged and above the sliding switch there is an additional key. A mobile telephone unit, data transfer unit, data processing unit, data visualization unit and dictating device unit integrated in the combination device share the components and function units necessarily present for these functions, for example the microprocessor and memory. A disadvantage hereby is that simultaneous operation as dictating device and mobile phone or for data transmission is possible only to a limited extent. However, with the use of modern microcomputers or microcontrollers and an operational software with multitasking ability, this problem does not arise. For example, with the agreement of the speaking partners, telephone calls can be inserted.

Furthermore, the combination has a slit for memory cards through which external memory media, for example miniSD, SD cards, multimedia cards, etc., can be inserted into the combination device. In this way the memory of the device can be expanded and also larger amounts of data can be exchanged.

For example, extensive dictation, recordings of telephone conversations, or external programs that are performed by the combination device, or data can be stored. These data can then be exchanged with other devices.

Moreover, the combination device has at least one radio interface and/or a USB interface in order to be able to enter into combination or communication with other devices. The radio interface is, for example, designed as an infrared interface, Bluetooth interface or WLAN interface.

The dictation that is stored and/or created in the combination device in the form of digital files can be transmitted smoothly via these interfaces, for example, to a computer, in order to be processed further there. However, there is also the specific possibility of transmitting the dictation through the mobile telephone function to another participant. Especially, in the design of the smartphone-mobile telephone part of the combination device, as an HSCSD/GPRS/UMTS mobile telephone, comfortable transmission of digitally stored and compressed dictation is possible. In this way, it is also possible to transmit data and receive data. This can occur between another participant, a computer, for example from the internet, etc.

Since the functioning of a combination device according to the invention is very extensive, and it is difficult for the user to evaluate and use all functions appropriately and intuitively, especially the slide switch is very advantageous. The slide switch has at least three positions, whereby in the middle positions it is in the rest position. Below and above the rest position there is in each case another switch position. However, the sliding switch does not remain in one of these positions, but rather, when released, returns to the rest position. This springing back is realized by having springs, squeezable elements or other devices present at the endpoints of the sliding switch, which deform under pressure, and when the pressure is released they return to the original function. As a result of this, the switch can remain in this position only when pressure is applied. When the sliding switch is released, it springs back to the rest position.

Above the sliding switch a key is arranged which, like all the other switches and keys of the combination device, realizes a different function in each case, depending on the selected function of the combination device. When operated as a mobile telephone or PDA, this key is assigned the function “enter” or input confirmation. When functioning as a dictating device, then the recording of a dictation is started with this “record” key.

The sliding switch also has different functions depending on the type of operation of the combination device; for example, when operating as a dictating device, it has the functions of speech recording, forward and reverse, and when operating as PDA or mobile telephone it has the functions “scroll up” or “scroll down,” or it serves for navigating through the menu shown in the display or through the data and datasets shown there (as also the selection in the telephone book). During the telephone conversation, the sliding switch also assumes the control of the loudness. In cooperation with the integrated digital cameras customarily used today, the sliding switch can also assume the zoom function, and the input key can trigger the photo.

The individual functions of the combination device, for example the dictating function, telephone function or PDA function are switched through the keys arranged above the decimal keyboard and switching can also be done through the touchscreen or through the sliding switch and the key arranged above it. Depending on the selected function, the individual keys and switches have different functions. The keys and the sliding switch thus have at least a twofold function.

In this way according to the invention, using the sliding switch, the combination device can be operated intuitively and without any problems.

The combination device according to the invention will be explained below with the aid of drawings.

In order to facilitate the understanding of the present invention, in the figures only those components of the practical examples are shown that are of importance in connection with the invention.

The following are shown

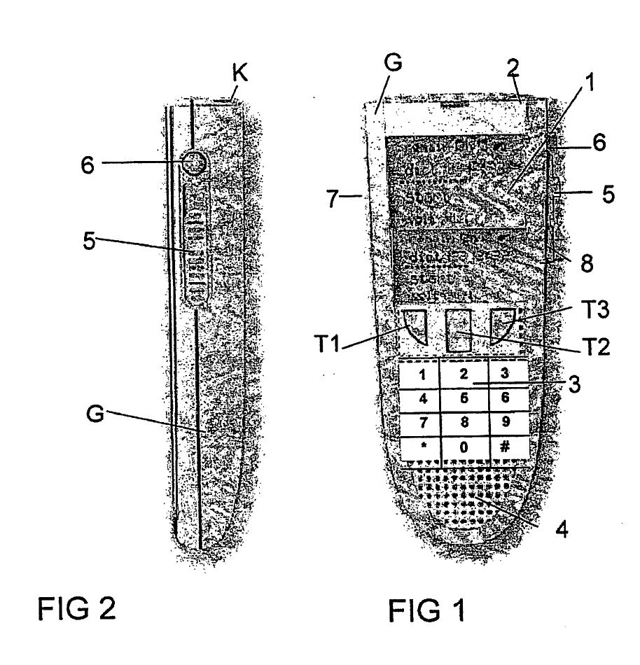

FIG. 1. is a top view of the combination device and

FIG. 2. is a side view of the combination device.

FIG. 1 shows a top view of the combination device. The combination device consists of a handheld housing G. The housing G has an oval shape on the bottom. The combination device has a large display 1 on its front side, which is preferably realized as a touchscreen. A keyboard 3 is arranged below display 1. This keyboard is a decimal keyboard that is, as such, familiar. At least two other keys T1, T2, T3 are arranged above this keyboard 3. Below the keyboard 3 there is an acoustic input unit 4, which is preferably realized as a microphone. In an advantageous further development of the invention, a second microphone is integrated into the combination device. The second microphone is arranged in the lower region of housing G and serves for speech input during telephone operation.

An acoustic output unit 2 is arranged at the upper part of housing G, which is realized in the form of a loudspeaker. In an advantageous further development of the invention, on the back side of housing G another loudspeaker is integrated as well as a second microphone. However, the second loudspeaker can also be arranged on the front side of the housing and serves for better understandability of the acoustic outputs, such as speech, etc. A rocker switch 7 is integrated into the housing G on the left side of the combination device. A sliding switch 5 is arranged on the right side of housing G and another key 6 is located above the sliding switch 5. This key 6 is realized in an advantageous embodiment of the combination device as a key which remains in the pressed position when first pressed and then leaves this position only when pressed again.

A mobile telephone unit, the functionality of a PDA and a dictating device function are integrated in the combination device, whereby the mobile telephone unit, the functionality as PDA and the dictating unit share the elements that are necessary for this functionality and this unit for their operation, for example microprocessor, energy supply unit and data storage. The combination device realizes the known functionality of a PDA, a mobile telephone and a dictating device in a single device.

Below, description of the devices, units and arrangements present within the device itself for operation as mobile telephone, dictating device or PDA will be omitted, to the extent that they are not relevant to the characteristics that are essential for the invention application.

The combination device has a card input slot through which external storage media, for example miniSD, SD cards, multimedia cards, etc., can be inserted in order to extend the memory of the combination device. In this external storage medium, for example, extensive dictations or telephone conversation recordings or external programs that are carried out by the combination device, or data can be stored. These data then are exchangeable.

The combination device has at least one radio interface in order to enter into combination with other devices; this radio interface is designed advantageously in the form of an infrared interface (IrDa interface) or a Bluetooth interface. Moreover, the combination device has a USB interface. Dictation or existing data input into the device can be transmitted without any problem through these interface, for example to a computer or to a third device, in order to be processed there further.

However, there is also the possibility of sending the data and dictation stored in the combination device to a third party through the integrated mobile telephone. It was found to especially advantageous for data transmission when the mobile telephone operates according to the HSCSD/GPRS/UMTS standard.

Since the function and the manner of operation of the combination device according to the invention is very extensive, and it is hardly possible for a user to utilize all the assigned functions intuitively, the slide switch 5 is very advantageous for the use of the combination device. The sliding switch 5 has at least three contact positions, and in the embodiment described below, four contact positions. The sliding switch 5 has two positions in which it remains when shifted, and one end position on each end from which the sliding switch springs back into one of the other two positions when the user lets go of the sliding switch 5 in this position.

In each mode of operation of the combination device the slide switch 5 has different functions. In the functioning of the combination device as a dictating device, the sliding switch 5 is in the normal position, whereby in the dictating function it then has a stop function. Below this function there is another lock-in position for starting the speech recording. Below this function another function is provided, for example as a reverse function for the already-stored dictation. The sliding switch 5 does not remain in this reverse function, but it springs back to the previous position when it is let go. Above the stop function a similar function is realized. Here, too, the sliding switch jumps back into the previous position. This jumping back is realized by providing springs or squeezing elements at the end points of the sliding switch 5, which, under pressure, simply deform, and when the pressure is released they return to their original shape. As a result of this, the sliding switch can remain in this position only when pressure is applied to it. When released, it springs back to the previous position.

The individual functions of the device, such as, for example the dictating function and the telephone function, are switched through keys T1, T2, T3 arranged above the decimal keyboard 3. Switching can occur through input via the touchscreen or by the selection of a menu point on display 1 with the aid of the sliding switch 5 and key 6, as will be described further, below. Depending on the combination device function selected, the individual keys 3, T1, T2, T3, 6, 7 and also the sliding switch 5 have different functions, and thus the keys 3, T1, T2, T3, 6, 7 and the sliding switch 5 have double function.

The initially-described function of the sliding switch 5 during dictation is realized during operation of the combination device as PDA by the function choice “scroll up” and “scroll down”. The outermost positions of the sliding switch 5 have these functions. Intuitively, it is especially advantageous to have the “scroll up” at the uppermost switching point and the function “scroll down” at the lowermost switching point of the sliding switch 5 assigned to it. When these functions are chosen by the user, this function provides rapid scrolling upwards of the display on display 1, while the lowermost position of the sliding switch 5 provides rapid scrolling down of display 1. In this way, the screen can be maneuvered intuitively and without any problems. Key 6, which is arranged above the sliding switch 5 is implemented as enter function in the PDA operation and mobile telephone mode. In the dictating operation it serves for controlling the dictation (or other functionalities, see above).

For example, if the combination device is in the mobile telephone operation and, for example, if the address book is opened, then, using the sliding switch 5, by shifting it up and down, one can scroll through the address book upward and downward, whereby the actually-selected address is always advantageously placed in a bar or marked visually. By activating key 6, which has the enter function, this highlighted address is selected and, for example, the corresponding telephone number is chosen.

In this way, it is possible to navigate through a menu without any problems. Furthermore, as already described, it is possible to carry out the dictating function as well as other functions in a way that is intuitive for a user. Thus a user can operate the combination device in an ergonomically meaningful and intuitive manner without having to look at it constantly, or having to operate with input devices that are not very ergonomic.

In order to realize navigation on a display 1 not only in the up and down directions, optionally using the rocker switch 7, a shift of the selection bar, as it is known from various devices, can occur in the vertical direction (for example during sideways scrolling in a calendar). When the rocker switch 7 is moved upwards, the selection bar moves to the left and when the rocker switch 7 is moved downwards it moves in the opposite direction.

Furthermore, for example with keys T1, T2, T3, one can switch between the individual functions of the combination device. For example, by pressing the key T1, the combination device is set into the dictation mode, upon activating key T2 into the mobile telephone mode and upon activating key T3 into the PDA mode.

Supposing that the combination device is in the PDA mode and a telephone call comes in, then the combination device signals the user about the incoming telephone call. By pressing one of the keys T1, T2, T3, for example T2, the telephone call is answered and the combination device switches to the mobile telephone mode. At the same time, the device is set into the “hold mode” and all open programs and files are secured. After completing the telephone call, the combination device can be designed advantageously in such a way that then, for example by pressing the key again, it automatically changes back into the previous mode.

Supposing the combination device is in the dictation mode and a telephone call arrives, then the combination device signals the user about the incoming telephone call. By activating one of keys T1, T2, T3, for example key T3, the telephone call is answered and the combination device switches into the mobile telephone mode. At the same time the present dictation is stored and secured. After completion of the telephone call, the combination device can be equipped advantageously in such a way that it will return automatically to the previous mode, in the described case to the dictation mode, and it adjusts itself so that the dictation can be continued at the place where it was at the time of switching to the mobile telephone mode.

Furthermore, the device may have a so-called “Non-GSM mode” or “airplane mode”. In this state, the mobile telephone unit of the device is deactivated by the user—by menu control or with a special key/switch, so that no disturbing influences/radio waves are emitted/received. This mode is necessary to use the device in special environments that do not permit the use of a radio telephone (airplane, certain areas in hospitals, etc.)

In addition, data can be sent with the combination device as well as received. Data can be received from the internet, from any arbitrary data network and also transmitted to these.

1-31. (canceled)

32. Combination device consisting of a housing G, which can be hand held, whereby the combination device integrates the functionality of a dictating device and a data transmission unit for speech and data, and the housing (G) is equipped with a visual display unit (1), an acoustic output unit (2), an acoustic input unit (4), at least one tactile input unit (3), whereby this consists of a decimal keyboard and at least two further keys added to this and another switch arranged on the side of the combination device, and the switch arranged on the side is a sliding switch (5), wherein:
the sliding switch (5) has a switching point at least in each switching direction, whereby with the aid of the sliding switch (5) functions of the combination device can be selected, and that on the side opposite to the sliding switch (5) of the combination device a key (7) is arranged, which serves for confirming or selecting the function selected via the sliding switch (5).

33. Combination device according to claim 32, wherein the key (7) is a rocker switch, and this can also be arranged alternatively on the front side of the housing (G) and has at least one switching point in the horizontal—but also alternatively in the vertical—activating direction.

34. Combination device according to claim 32, wherein the data transfer unit for speech and data is a mobile telephone unit and that a key (6) is arranged on the housing (G) above the sliding switch (5) and/or the mobile telephone unit is a smart phone, and the integrated mobile telephone unit operates according to the HSCSD and/or GPRS and/or UMTS standard.

35. Combination device according to claim 32, wherein the visual display unit (1) is a display and that the display is designed as a touchscreen display, whereby the functions of the combination device can be controlled via the touchscreen display.

36. Combination device according to claim 32, wherein the combination device can be brought into the various modes of operation with the aid of the additional keys (T1, T2, T3).

37. Combination device according to claim 32 wherein all keys of the tactile input unit (3), of the sliding switch (5) as well as the key (6) and the rocker key (7) have at least double functionality, and the double functionality is switched through a toggle which can be placed freely onto one of the keys.

38. Combination device according to claim 32, wherein the sliding switch (5) serves in the telephone mode for up and down scrolling of the displays on the visual display unit (1).

39. Combination device according to claim 32, wherein the operating mode as dictation device, the sliding switch (5) realizes the operating functions for recording, start, stop, fast rewind, fast forward, etc., and/or in the operating mode as dictation equipment for starting the recording of dictation, the sliding switch (5) has an assigned locking position in which it remains upon shifting.

40. Combination device according to claim 32, wherein the sliding switch (5) is guided into its particular end positions via springs or bent metal pieces and as a result of this, when one lets it go in this position, the sliding switch (5) springs back into the previous position, and/or the sliding switch (5) has ergonomic ridges and a raised part, which permit intuitive operation and sensing of the switch position.

41. Combination device according to claim 32, wherein the combination device has a photography unit and that in the photo mode the sliding switch (5) serves to increase or lower the zoom factor.

42. Combination device according to claim 32, wherein upon turning on, the combination device first goes into the telephone mode and that the key (6) or the key (7) has the enter function in the telephone mode.

43. Combination device according to claim 32, wherein the rocker switch (7) serves to control the sound volume.

44. Combination device according to claim 32, wherein the combination device, when a telephone call is received during dictation, signals the user about this via a display on the visual display unit (1) and/or a vibration unit integrated in the device and/or the acoustic output unit (2), and the user, by activating one of the additional keys (T1, T2, T3) assigned to the decimal keyboard, can take the telephone call, and hereby the present dictation worked on is stored at the actual point where it is, the telephone call is taken, and after completion of the telephone call the device returns to the state in which it was before the receipt of the telephone call.

45. Combination device according to claim 32, wherein the combination device permits recording of a telephone call within the framework of the legal regulations.

46. Combination device according to claim 32, wherein another visual display unit is present, which blinks in the dictation mode during recording.

47. Combination device according to claim 32, wherein the operation of the combination device and its functionality is performed through an additional keyboard arranged on the combination device and/or through other operating elements, whereby the additional keyboard is a qwerty keyboard.

48. Combination device according to claim 32, wherein the acoustic input unit (4) in the dictation operation serves for speech input, in the telephone operation serves for speaking, and in the operation as PDA it serves for speech control of the PDA with the aid of a speech recognition program.

49. Combination device according to claim 32, wherein the combination device transmits stored data and dictation through the integrated mobile telephone unit to a third party.

50. Combination device according to claim 32, wherein the combination device has at least one radio interface and/or a USB interface with the aid of which the combination device can enter into combination or communication with other devices, whereby the radio interface is an infrared interface, a Bluetooth interface or a WLAN interface.

51. Combination device according to claim 32, wherein the combination device as dictating device is set up with the sliding switch (5) in the operating mode in the normal position with a stop function, and below this function the other locking position with the function for the starting of the speech recording and below this locking position other functions as the reverse function for the already-stored dictation.

52. Combination device according claim 32, wherein the combination device has a non-GSM mode or airplane mode, whereby in the non-GSM mode or airplane mode the mobile telephone unit of the combination device is deactivated so that no disturbing influences and/or radio waves are received or emitted.
